(19) United States
(12) Patent Application Publication
(10) Pub. No.: US 2005/0184478 A1
(43) Pub. Date: Aug. 25, 2005

(54) Rough-terrain transporter

(76) Inventor: Thomas A. Ruedy, Oak Grove, OR (US)

Correspondence Address: THOMAS A. RUEDY, 6301 SE BROWNLEE ROAD, MILWAUKIE, OR, 97267, US

(21) Appl. No.: 10/773,824

(22) Filed: Feb. 9, 2004

(51) Int. Cl. B62B 1/00

(52) U.S. Cl. 280/47.25

(57) ABSTRACT

A Rough-Terrain transportation apparatus for mobilizing injured or disabled individuals. The Rough-Terrain Transporter made of lightweight steel alloy comprised of a Mainframe with a Seat, the Seat having a back rest, having one wheel or ski, and extended handles in the front and rear. A wheel or ski beneath the Seat is centered between the sides, and centered at the balance point between the front and rear. The Rough-Terrain transporter has a Shock Absorber attached at the rear of the Wheel or Ski Support Structure for comfort during use. The Shock Absorber is mounted between the Wheel or Ski Support Structure and the base of the Seat on the Mainframe. The Wheel or Ski Support Structure and Front Extension Handles structure pivot at a common point at the front of the Mainframe.

### BACKGROUND OF THE INVENTION

| PAT. NO. | Title |
|---|---|
| 1 6,619,414 | Personal mobility vehicle |
| 2 6,578,854 | Personal mobility vehicle incorporating tilting and |
| | swiveling Seat and method for use while playing golf |
| 3 6,530,445 | Variable wheelbase personal mobility vehicle |
| 4 6,467,785 | Wheelchair with adjustable Seat |
| 5 6,412,804 | Wheelchair with improved suspension |
| 6 6,371,228 | Stable powered tricycle with traction steering |
| 7 6,302,421 | Vehicle with swivel control of casters for enabling rider |
| | or external steering |
| 8 6,230,831 | Wheel chair with auxiliary power |
| 9 5,964,473 | Wheelchair for transporting or assisting the displacement of |
| | at least one user, particularly for handicapped person |
| 10 5,951,103 | Foldable combination chairs and table |
| 11 5,913,373 | Dual-pole, dual-wheel personal towing vehicle |
| 12 5,769,442 | Structural shell frames and method of making same |
| 13 5,735,361 | Dual-pole personal towing vehicle |
| 14 5,634,650 | Recreational wheelchair |
| 15 5,624,128 | Transport system for disabled people |
| 16 5,518,081 | All-terrain, all-weather wheelchair |
| 17 5,470,093 | Auxiliary wheelchair attachment for pulling a wheelchair |
| 19 5,064,209 | Combined trailer/wheelchair |
| 20 4,460,190 | Hand propelled wheelchair |

1) Field of the Invention

This invention relates to personal transportation for pulling a user over a variety of base surfaces. More particularly the invention relates to expedient and efficient travel over rough or uneven terrain.

2) Prior Art

Other pulling transport systems are known in the art. The best prior art known to Applicant are U.S. Pat. Nos. 6,619,414; 6,578, 854; 6,530,445; 6,467,785; 6,412,804; 6,371,228; 6,302,421; 6,230,831; 5,964,473; 5,951,103; 5,913,373; 5,769,442; 5,735,361; 5,634,650; 5,624,128; 5,518,081; 5,470,093; 5,064,209; and 4,460,190.

The best prior art to Applicant is U.S. Pat. No. 5,470,093, that pertains to a wheelchair attachment for enabling an occupied wheelchair to be pulled or pushed by an attendant.

1) This vehicle consists of two poles with handles that project forward of an attached two-wheeled wheelchair. Though the vehicle will operate properly in ideal conditions, numerous problems will arise when the user or environment is altered. This is explained as follows:
A) Because the vehicle has two wheels, one on each side, and is balanced by the attendant(s), it is the user who must always maintain the balance of himself/herself in the wheelchair as the vehicle tips from side to side.
Maintaining this balance could be an impossible task if the vehicle is traversing a cross-sloped surface or if the user does not have sufficient body strength to overcome a vertical shifting of the handle position, e.g., going down a hill.
B) While the object of pulling or towing a vehicle is to provide a means of forward movement, it should also provide the user a measure of comfort. If the pulling handles and pushing handles are rigidly attached to a wheelchair without a hinge point, the vehicle will not comfortably follow the terrain that the attendants and the wheelchair are traveling upon. While negotiating a turn at a quick pace on level ground, gravity and centrifugal forces cause the vehicle and user to become unbalanced in the same vector direction. Thus the two-wheeled vehicle will tip in the same direction as the user, aggravating his/her imbalance.
C) Steering a two-wheeled vehicle is difficult because it assumes the attendants have sufficient strength, balance and control to oppose the forces needed to maneuver the vehicle over rough terrain or uneven surfaces. Since the steering requires sufficiently strong and balanced attendants, it follows that if the attendants are not strong and coordinated, they will be unable to move the vehicle smoothly.
D) The above liabilities are proportional to the weight of the user. This becomes an added problem since the endurance of the attendants is contingent upon the load they are required to maneuver.

Another prior art vehicle system is found in U.S. Pat. No. 5,624,128 and is designed for transport of disabled individuals having a frame for carrying a driver, drive wheels, at least one front wheel, a back support and a push structure. The front wheel is connected to a rotating fork that is mounted to the front of the frame by a fork mount. This complicates the operation of the apparatus because of an additional frictional contact with the front wheel on the ground. The push structure is not good for overcoming obstacles because of pre-wheels connected to the frame ahead of the drive wheel mounts. For travel on narrow trails, the pre-wheels are removed from the side mounts and connected to an auxiliary mount attached to the rear of the frame. This detracts from the convenience of operation and still, the apparatus width precludes use on narrow passageways.

3) Discussion of Alternative Art

The primary means of accessing off-road locations for hiking, currently available to mobility-impaired individuals, is motorized vehicles. That substantially limits the locations that disabled people can legally access and greatly diminishes the recreational wilderness experience. These problems stem largely from the limitations that conventional wheelchairs and other wheeled transport devices impose on their users.

The limitations of conventional wheelchairs and other wheeled transport devices render almost all natural settings completely inaccessible to the disabled. Those limitations create an unfortunate deficit in the lives of disabled people. The preferred embodiment is specifically designed to remedy problems wheeled transport devices encounter when used for conveying the injured or disabled.

Wheelchair users and others who must use wheeled aids are confined to smooth, hard and side-level surfaces. Commercially available manual wheelchairs are much too fragile to withstand the rigors of cross-country travel. Attempting to travel over uneven terrain in a wheelchair is a dangerous and frustrating endeavor that often results in serious injury. Manual wheelchairs are very difficult for one or more able-bodied attendants to maneuver. Attempts to assist in off-road wheelchair expeditions often result in back injuries to the attendants.

Another significant impediment confronted by disabled people is narrow pathways. That problem is extremely common in remote areas where pathways are not wide enough for a two-wheeled transport device to pass. Despite recent federal legislation mandating the removal of man-made barriers to wheeled transport device users, problems remain. In many parts of the United States, particularly in wilderness regions, there is lax compliance with the federal laws regarding the widening of pathways. In foreign countries, the accessibility problem is commonplace.

In a rescue operation to extricate an accident victim, using a standard gurney with one large wheel firmly mounted beneath the gurney makes for an uncomfortable ride. The movement jolts the occupant of the gurney and makes it difficult for the attendants to maneuver the gurney. Because of the vertical and horizontal location of the forward and rearward-oriented handles, the attendants will have difficulty in pushing and maneuvering an occupied gurney over rough terrain. Attempts to push an occupied gurney up a slope or hiking path can cause much difficulty and the attendants may find the task impossible.

To remedy the above problem, the present invention describes an unobtrusive transport apparatus for injured or disabled individuals. The present invention readily permits passage of the apparatus through narrow or nonexistent pathways. Those aforementioned two-wheeled chair problems stem largely from the limitations that conventional wheelchairs impose on their users. A two-wheeled wheelchair or hiking chair will tip to the side on an uneven trail or pathway, causing the user discomfort from the sideways leaning of the chair.

The front and rear handles of the present invention allow the attendants pulling and pushing the transport apparatus to maintain the balance of the transport apparatus without the transport apparatus bouncing and rocking from side to side. The present invention will not tip forward or backward more than the attendants can or will allow.

The invention will be better understood by reference to the following detailed description in connection with the accompanying drawings.

### BRIEF DESCRIPTION OF THE DRAWINGS

FIG. 1 A drawing of the preferred embodiment (side view) showing major components.

FIG. 2 A detail drawing of components of the preferred embodiment; this is an isometric view of the apparatus for use on rough terrain surfaces according to the invention.

FIG. 3 A detail drawing of the Wheel or Ski Support Structure.

FIG. 4 A drawing of the Detail view of the Pivot Shaft; an isometric view of a pivot Shaft which acts as a hinge point for the preferred embodiment for use on rough terrain surfaces according to the invention. The pivot Shaft with washer welded at one end and spring clip mounted to other end are shown with pivot Shaft tubes assembly.

FIG. 5 A drawing of a Harness for attendants to pull the transporter.

FIG. 6 A drawing of the folded Transporter for stowing.

FIG. 7 A drawing of a second embodiment with ski assembly attached. An isometric view of a Rough Terrain Transporter for use on ice or snow-covered surfaces.

FIG. 8 Four color pictures of the preferred embodiment in use.

### SUMMARY OF THE INVENTION

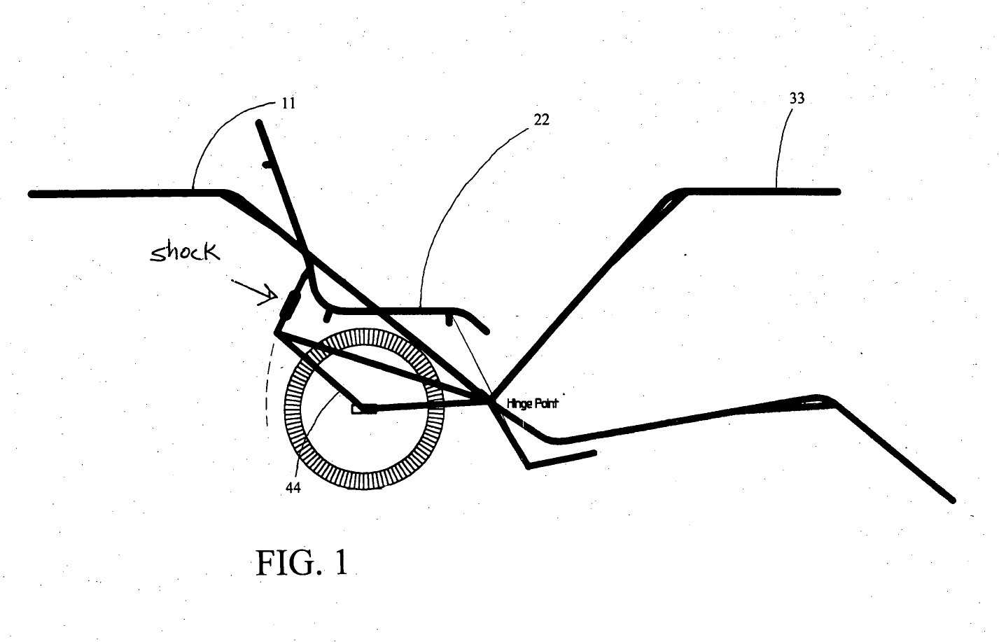

Referring to the drawings and initially to FIG. 1, the present invention relates to transportation systems and the disabled. The present invention is designed in its preferred embodiment to allow the Rough-Terrain Transporter to be moved over rough terrain carrying a disabled or injured individual.

The present invention withstands rugged treatment and is stable due to a low center of gravity and long extension handle base. The present invention is not self-propelled by the user. It is a manually powered, off-road transport system. Unlike a conventional wheelchair, the attendants power the apparatus independently. The present invention incorporates mechanisms that provide for the assistance of two or more able-bodied attendants.

The present invention is designed for use in rugged environments, including: hiking trails, beaches, rural areas, and bush villages in regions like Alaska. The transport apparatus permits disabled people to participate in hiking, camping and other outdoor activities that are currently impossible in the absence of an off-road transport system.

The present invention provides the user:
1) A means of traversing rough terrain.
2) A means of stability and balance.
3) Positioning control and smooth comfort during operation.
4) Minimum effect on the body's natural orientation on the apparatus.

The apparatus's design also offers a “user-friendly” portability, which makes transporting and handling the device easy. The lightweight, easy-to-fold structure can be tilted in any orientation when loading or unloading from a vehicle. The entire structure can be disassembled into four pieces each weighing less than 10 lbs. for lightweight backpacking for distance trekking.

### DETAILED DESCRIPTION OF THE PREFERRED EMBODIMENTS

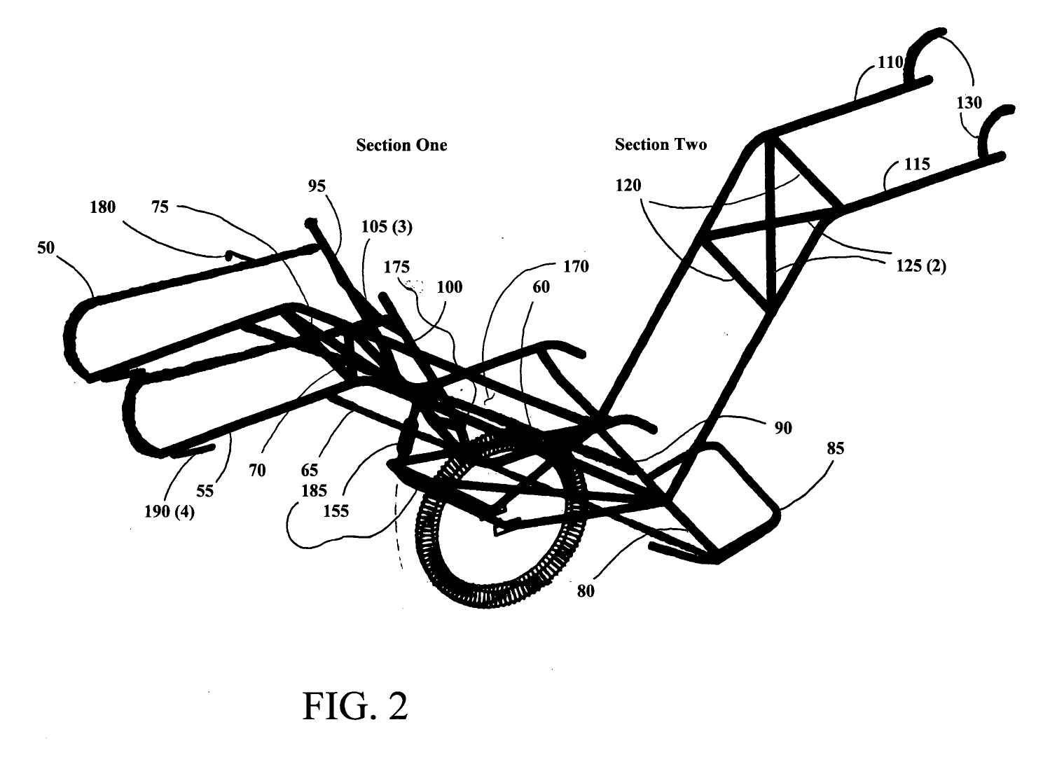

The present invention comprises a Mainframe that is the primary component of the Rough-Terrain Transporter. FIGS. 1-2 show one embodiment of the present invention having a Mainframe (FIG. 1, 11, 22) pivotally connected to the Front Extension Handles 33 and the Wheel or Ski Support Structure 44.

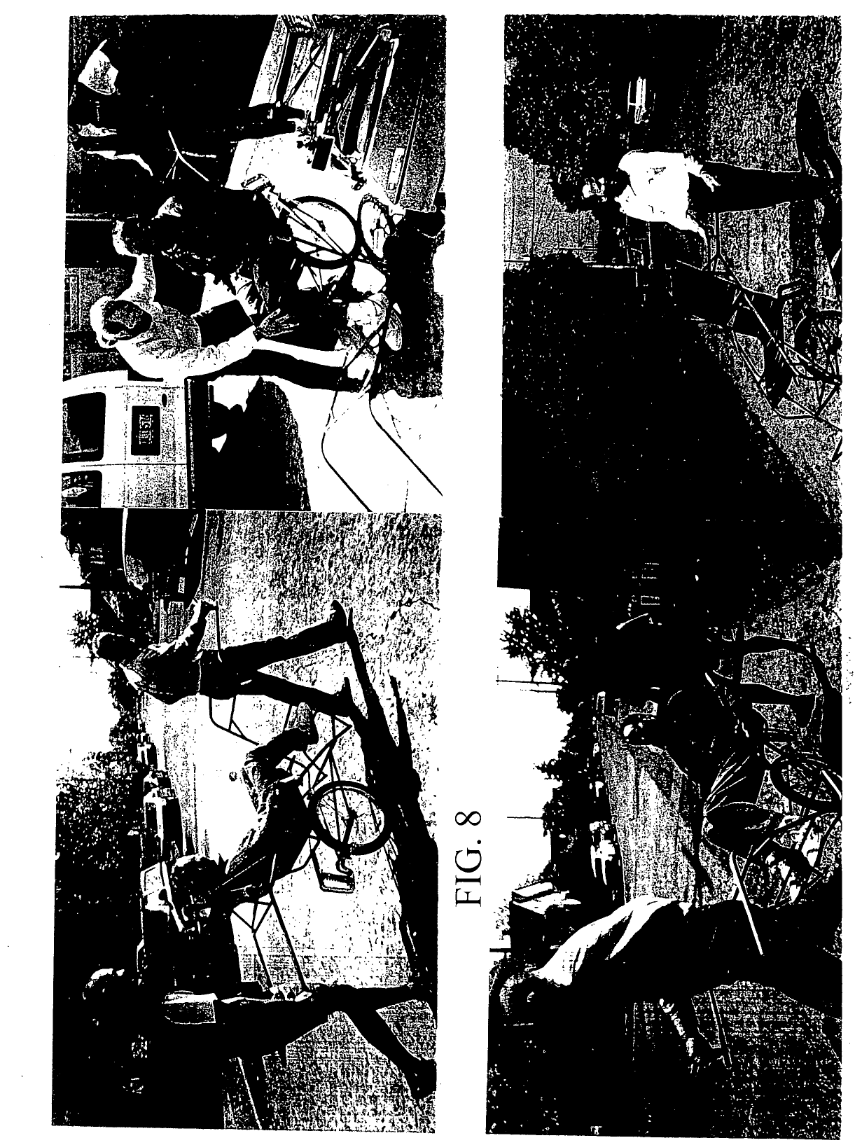

The Mainframe can take various forms, but typically provides a pair of tubular side frames (FIG. 2, 50, 55, 60, 65) having cross supports 70,75, 90, 105. The Transporter in FIGS. 1-8 shows a preferred design of the present invention. The Mainframe FIG. 1, 11 and rear extension handles comprise continuous tubular members. The tubular members are bent into a loop FIG. 2, 50, 55 at the rear and interconnected by welded tubular cross members 70, 75, 90, 105.

The transporter is propelled and maneuvered by two attendants, one at the front of the front extension pull handles 110, 115 and the other at the rear of the rear extension push handles 50, 55. The rear extension push handles extend from the rear of the Seat backrest 95, 100 to the rear of the Mainframe. The space between the backrest and the rear extension push handles cross supports 70, 75 can be used as a place to store a backpack, rescue gear or supplies. The push structure 50, 55 can be grasped by either the lower or upper rear handles by the rear attendant.

The Front Extension Handles 110, 115 comprise a pull structure having horizontal members 120, 125 extending across the front and rear of the Front Extension Handles for increased stability. The pull structure having vertical aluminum handgrips 130 whereby able-bodied attendants can comfortably walk or run and laterally stabilize the apparatus. The Handgrip clamps 130 attached to the Front Extension Handles, when grasped by an attendant, thereby enable the attendant to pull more easily for guiding the present invention from the front.

The Front Extension Handles 110, 115 are mounted to the forward most pivot point, the pivot Shaft 90, on the Mainframe and extend forwardly of the Mainframe in a generally horizontal plane. The Shaft 90 will secure the adjacent sections together against whatever rolling force the chair reasonably can be expected to undergo while in use. The ability of the apparatus to flex at the hinge point is helpful to clear an unavoidable obstacle on a path or trail. The footrest of the device clears the ground by seven inches while in operation. The standard design has a frame that is twelve feet long and one-and-one-half feet wide.

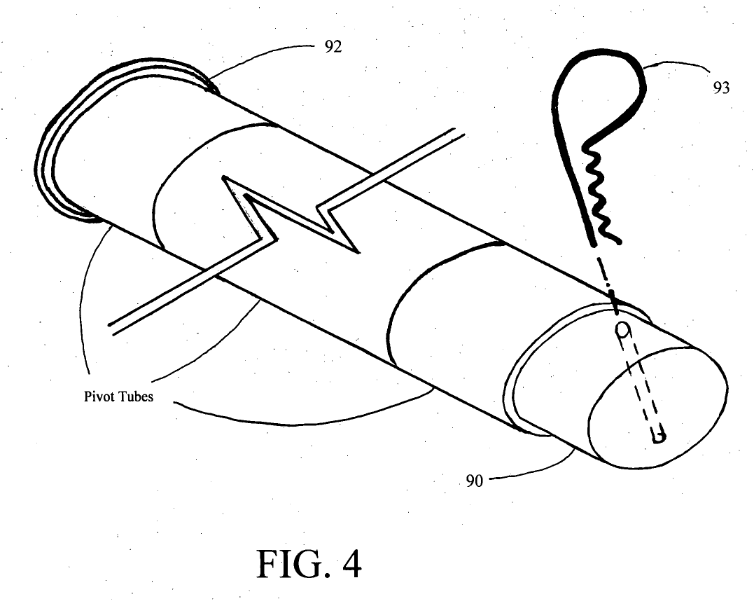

The entire present invention would be provided in two sections, one being the Mainframe 50, 55, 60, 65. A Shaft 90 attaches the second section, the Front Extension Handles 110, 115 to the Mainframe. As shown in detail view FIG. 4, an appropriate Shaft 90 with an over-sized washer 92 is welded on one end to stop the Shaft 90 from sliding through the pivot tubes. And at the opposite end of the pivot tubes, is a spring clip 93 to secure the Shaft 90. The Shaft is inserted into the pivot tubes to allow sections one and two, to pivot freely. Similarly, the Wheel or Ski Support Structure is welded to the pivot tubes to support the preferred embodiment at its hinge point.

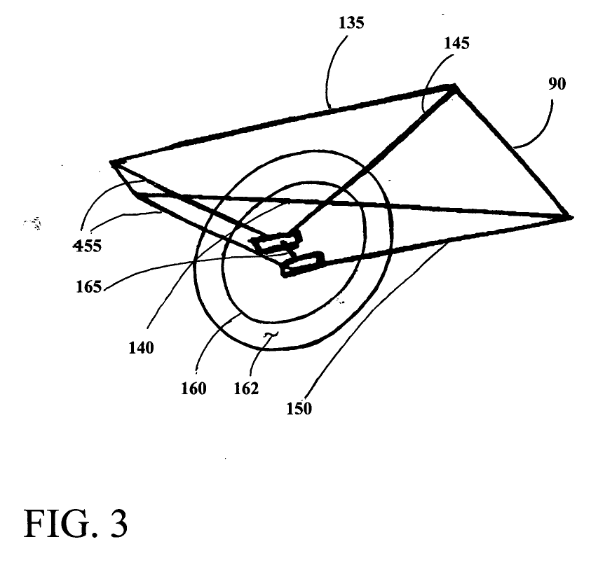

Referring to FIG. 3, the present invention has a wheel 160 preferably with wire spokes and 20″ in diameter, mounted to the Wheel or Ski Support Structure 135, 140, 145, 150, 455 at the Axel 165. This support structure holds the Axel 165 rigid laterally to allow the present invention to roll across the ground. For rugged uses like cross-country travel, a standard inner tube in the tire 162 is replaced with a flat-proof, tubeless insert to prevent flats. A brake 185 is mounted on the wheel support structure at the rear of the wheel 160.

The present invention has a Shock Absorber (FIG. 1, 155) between the Mainframe and Wheel or Ski Support Structure to provide for a smooth ride for the user. The Shock Absorber 155 is attached to the Mainframe beneath the rear of the Seat, in a relatively vertical orientation, to the back of the Wheel or Ski Support Structure. The Shock Absorber 155 provides suspension to the present invention by stabilizing the structure vertically. The Shock Absorber dampens any oscillating motion from the up-and-down movement that may develop during operation from the attendants pulling and pushing the transporter in a forward direction.

The configuration of the Mainframe and Front Extension Handles having a pivot Shaft connecting the two structures, section one and section two, enables each individual attendant to determine the attitude of the plane of the Mainframe. Preferably this plane is generally horizontal, as shown in FIG. 1. This horizontal plane will enable the front attendant to position the forward end section 33 at an elevation that is near waist-height. With the present invention in this attitude, the attendants will find it easy and convenient to pull the occupied Rough-Terrain Transporter over rough or uneven terrain without unduly jarring the user.

In preferred embodiments of the present invention, the Mainframe 11 is designed for carrying a single passenger in the Seat 22. As shown in FIGS. 1-2, the user sits upright on the Mainframe 11 with legs extending forward. A back support FIG. 2, 95, 100 extends upward from the Mainframe, thereby allowing the user to sit comfortably in the Mainframe. The Seating is made of thick nylon fabric webbing 170 threaded in a criss-cross manner between the Seat frame sides 95, 100.

In the preferred embodiment a footrest 85 is connected on the lower Mainframe to provide support for the lower extremities and feet of the user. The user is secured in the apparatus by safety belts 175 with quick release buckles at the chest, waist, and ankles. The user can weigh up to 250 lbs. When balanced the present invention can be easily tipped forward and back and from side to side. This allows the attendants to control the direction of the transporter and to afford the user great comfort.

The present invention has a braking system comprising a Handbrake Lever 180 and Brake 185, the Handbrake Lever detachably mounted to the left extension handle at the rear of the Mainframe. The Brake mechanism 185 mounted at the rear of the Wheel or Ski Support Structure provides a clamp against the wheel, when the hand brake lever is depressed, to assist with slowing the transporter while in use and to provide for safe operation.

The preferred embodiment shown in FIGS. 1-4 comprises side members composed of two side segments (FIG. 2, 50, 55, 60, 65) welded together with interconnecting cross-members. The forward-most section, an open section, comprises the Front Extension Handles welded together with interconnecting cross-members 120, 125. The two sections are joined by adjacent pivot tubes at the front of the Mainframe section, by the Shaft 90. The Mainframe and Front Extension Handles, the Wheel or Ski Support Structure, and the cross-support members are all metal tubes.

The Shaft of the present invention shown in detail view in FIG. 4 as comprises a solid steel Shaft for insertion into the end of the pivot tubes. This segment would be tubular and of a suitable diameter for fitting the pivot Shaft into the tubes as appropriate. The diameter of the pivot Shaft would be such that bushings made of delrin® can be placed between the Shaft and the tubes to provide for a bearing-like surface. This allows for a fairly non-frictional operation so that the Shaft can pivot within the inside of the pivot tubes. By this arrangement, the longitudinal length and transverse width of the Mainframe sections facilitate tilting the Transporter front to rear and side-to-side with stability during operation.

In operation, the front attendant will proceed to pull the present invention behind him/her. To do so, the attendant will lift the forward end of the forward extension handles so as to raise the handles to waist height. Then as the front attendant pulls the Rough-Terrain transporter, the rear attendant supports the Mainframe, the Seat and the occupant while balancing the Rough-Terrain transporter from side to side in coordination with the front attendant. This coordination of effort between the front attendant and the rear attendant will afford the Rough-Terrain transporter user a relatively smooth ride; smooth over rough terrain such as hiking on a wilderness trail, a field, a graveled path or roadway.

In order for the front and rear attendants to comfortably move the Rough-Terrain transporter in the position illustrated in FIG. 1, the Mainframe and the front and rear extension handles must be rigid enough to resist impediments so that the attendants need only move the Rough Terrain transporter in a forward direction.

This requirement necessitates fabricating the Mainframe from relatively rigid, inflexible materials to impart the necessary stiffness and resistance for safe operation of the Rough Terrain transporter. For rescues and hiking in wilderness uses, where lightweight, strength and durability are important, the frame may be fabricated from chromium molybdenum alloy steel. The Rough-Terrain Transporter weighs 43 pounds. An important aspect, however, is that whatever material is chosen, the end product—the Mainframe, Front Extension Handles, and Wheel or Ski Support Structure—must not be made of lightweight or mild steel. Because of the strength of chromium molybdenum alloy steel, there will be little or no noticeable bending of the structure.

The horizontal orientation of the front and rear extension handles allows for operation by front and rear attendants of any stature. Thus the attendants can comfortably operate the present invention so it can sufficiently and adequately clear the ground for most passable terrain. The front support structure on the Mainframe comprises a footrest (FIG. 2, 85) for supporting the legs of the user. One can see, however, that if the Mainframe and Front Extension Handles were too flexible, maneuverability would be limited, especially on steep terrain. Moreover, a too flexible frame could effect an oscillatory bouncing action in the Rough-Terrain transporter due to the walking action of the attendants as they pulled and pushed the Rough-Terrain transporter along.

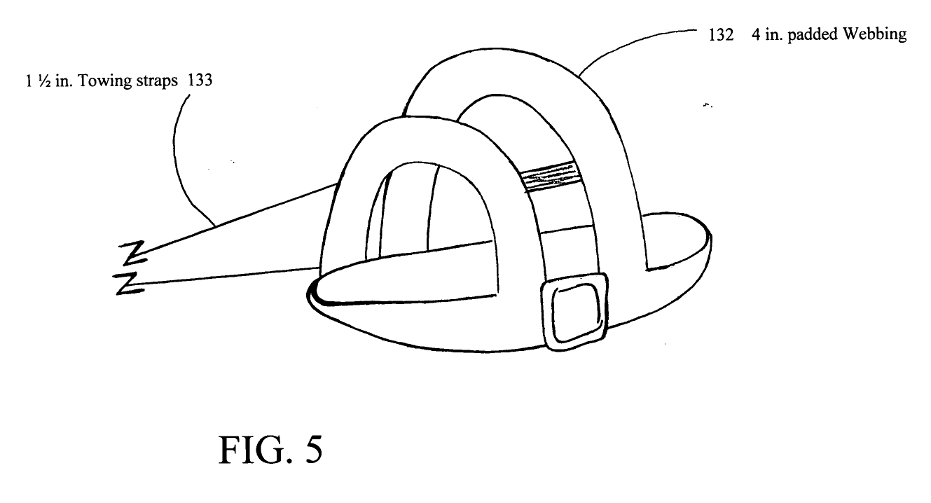

The present invention can be further equipped with towing Harnesses (FIG. 5, 132) when additional pulling power is needed. Shown as a preferred embodiment of a Harness 132 having wide (4 inches) nylon webbing, padded with foam rubber for comfort. The Harness 132 can be used by either or both attendants for greater pulling power or for slowing when going down steep inclines.

The Harness 132 is shown having 1½ inch wide towing straps 133, preferably of nylon webbing, that pull against the posterior pelvic region of an assistant. The Harness 132 is connectable to the Mainframe by strong clips such as mountain climbing carabineers. The carabiners attach to the towing straps 133 at the Mainframe and to the Harness on the posterior pelvic region.

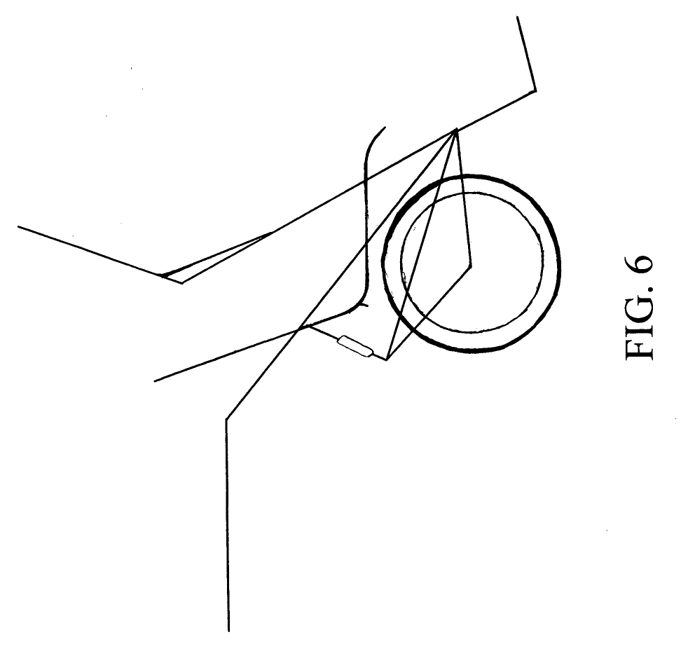

The apparatus of the preferred embodiment provides in FIG. 6 a compact assembly when folded in half, so that it may easily fit within an elongated space or compartment. When the present invention is to be stowed away, the various segments can be folded together to make a compact, more-easily stowed unit without having to dismantle the sections from one another. The Front Extension Handles can fold completely across the Seat to rest against the Seat 22 on the Mainframe 11 for transporting in a vehicle or for storage. This folding feature adds convenience when loading and unloading the apparatus from a vehicle or storage space.

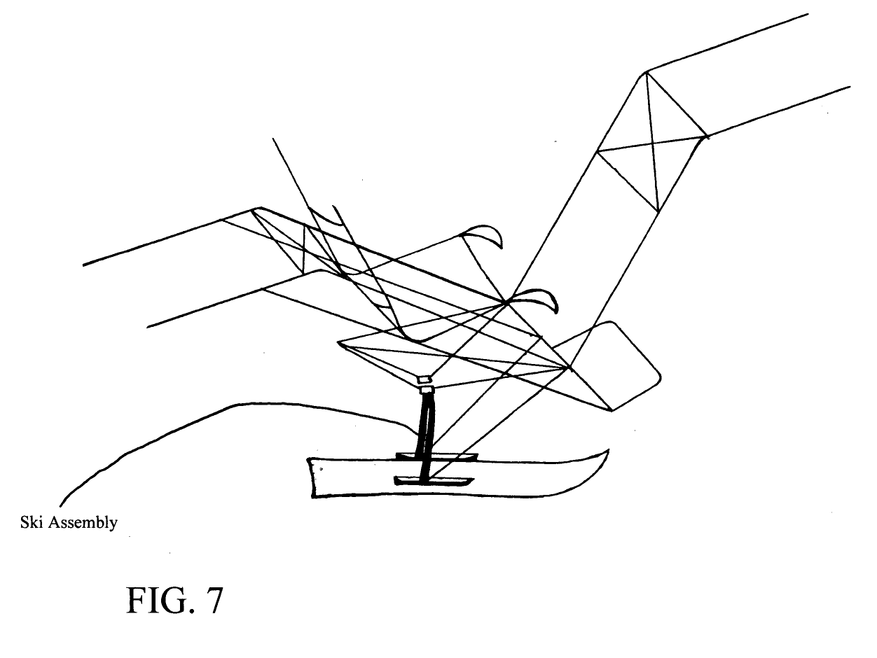

Other adaptations to the preferred embodiment may include a wide, inflated tire that can be used on sand or soft terrain for recreation or rescue of injured or dead accident victims. Also, the ski assembly attachment shown in its embodiment in FIG. 7 can be used for recreational downhill or cross-country skiing. The downhill or cross-country ski attachment can be utilized for snow rescues of injured or dead accident victims.

While the preferred embodiment of the invention has been described herein, variations in the design may be made. The scope of the invention, therefore, is only to be limited by the claims appended hereto. The embodiments of the invention in which an exclusive property is claimed are defined herein.

1. A transport apparatus for disabled individuals comprising: a Mainframe with a Seat, the Seat having a backrest. The Mainframe has two side support structures with extension handles projecting rearwardly behind the Seat. The present apparatus, a system for conveying individuals, comprises a Mainframe, a Seat connected to the Mainframe, Front Extension Handles that are pivotally connected to the Mainframe by a Shaft for pulling the transporter on a One-Wheel or Ski Support Structure. The One-Wheel or Ski Support Structure is also pivotally connected to the Mainframe on the Shaft for directly supporting the weight of the user.

2. The apparatus of claim 1, further comprising four major components: a Mainframe assembly comprised of two side support structures for conveying a user. The Mainframe, Seat, and rear extension handles combine to form one piece having the Seat welded midway between the front and rear ends of the side support structures. A common Shaft attaches the Mainframe to a second Front Extension Handles section. This Shaft allows the Front Extension Handles to pivot freely with the Wheel or Ski Support Structure to enable the transport apparatus to be moved easily on various types of terrain.

3. The apparatus of claim 1, further comprising a Wheel or Ski Support Structure to pivotally attach to this shaft at the front of the Mainframe. This Structure allows the apparatus to traverse rough terrain during operation.

4. The apparatus of claim 1, further comprising a Seat having two side frame members having a chair shape. The Seat also having a backrest, with curves that conform to the user's body. The Seat also having webbing straps woven between the two side structures to support the user's body weight.

5. The apparatus of claim 4, further comprising Seatbelts attached to the Seat frame to wrap around the chest, waste and ankles of the user to hold him/her securely in place while being transported.

6. The apparatus of claim 1, further comprising Front Extension Handles attached to the Mainframe by a common pivot Shaft so as to allow the Front Extension Handles to pivot freely.

7. The apparatus of claim 1, further comprising a Wheel or Ski Support Structure pivotally mounted to the Mainframe and the Front Extension Handles by a common Shaft. This allows the Wheel or Ski Support Structure to pivot freely.

8. The apparatus of claim 7, further comprising an Axel removably mounted in the center front to back between the sides of the Wheel or Ski Support Structure to pivotally attach a wheel or ski.

9. The apparatus of claim 7, further comprising a wheel with a tire made of durable material with large, gripping treads suitable for rugged travel or a ski for use upon snow or ice removably connected at the Axel.

10. The apparatus of claim 1, further comprising a Shock Absorber mounted at the back of the Seat between the back of the Wheel or Ski Support Structure and the base of the Mainframe behind the Seat.

11. The apparatus of claim 1, further comprising a Shaft, having a removable spring clip on one end, removably connected through pivot tubes. The Mainframe, Front Extension Handles and Wheel or Ski Support Structure pivot independently as a common hinge point.

12. The apparatus of claim 1, further comprising an adjustable Harness connectable to the Mainframe. The Harness having frame connectors for alternately connecting to the front of the Mainframe or the Front Extension Handles at the pivot point of the Mainframe and Front Extension Handles.

13. The apparatus of claim 1, further comprising a Handbrake lever and brake. The Handbrake lever is detachably mounted to the left extension handle at the rear of the Mainframe. A brake mechanism mounted at the rear of the Wheel or Ski Support Structure provides a clamp against the wheel to slow the transporter while in use and to provide for safe operation.

14. The apparatus of claim 1, further comprising a footrest to support the lower extremities and feet of the user.

15. The apparatus of claim 1, further comprising four (4) Kickstands mounted near the rear-most end of the rear push handles and above the footrest at the base of the front of the Mainframe beneath the Seat frame.

16. The apparatus of claim 1, further comprising the Mainframe, Seat, Wheel or Ski Support Structure and Front Extension Handles which are made of lightweight, chromium-molybdenum alloy steel tubing. The Mainframe and Seat are entirely welded together having no moving parts. The Wheel or Ski Support Structure and the Front Extension Handles are connected together at the pivot Shaft.

17. The apparatus of claim 1, further comprising Handgrip clamps attachably mounted to the Front Extension Handles thereto; the preferred embodiment is well suited for off-road or wilderness use when the Handgrip clamps are attached to both the front and rear extension handles.
